(19) United States
(12) Patent Application Publication
(10) Pub. No.: US 2025/0021763 A1
(43) Pub. Date: Jan. 16, 2025

(54) SYSTEMS AND METHODS FOR GENERATING SEMI-STRUCTURED TERM SHEETS USING NEURAL INFORMATION RETRIEVAL

(71) Applicant: JPMORGAN CHASE BANK, N.A., New York, NY (US)

(72) Inventors: Maxime LABONNE, London (GB); Sean MORAN, London (GB); Dan CLESHAM, Guildford (GB); Lily McINERNEY, New York, NY (US)

(21) Appl. No.: 18/766,138

(22) Filed: Jul. 8, 2024

Related U.S. Application Data
(60) Provisional application No. 63/513,058, filed on Jul. 11, 2023.

(51) Int. Cl. G06F 40/284

(52) U.S. Cl. CPC G06F 40/284

(57) ABSTRACT

Systems and methods are disclosed for generating a semi-structured term sheet. According to some embodiments, the systems and methods include receiving a brief description of a term sheet in a natural language format from a user interface connected to the electronic device; tokenizing the brief description to create a plurality of numerical values for a content of the brief description; using a large language model to retrieve information relevant to the brief description based on the tokenization; selecting a dynamic template database to the information retrieved by the large language model based on the retrieved information; querying the dynamic template database using the retrieved information to extract a term; and outputting the terms in a determined format based on the dynamic template database.

### RELATED APPLICATIONS

This application claims priority to, and the benefit of, U.S. Provisional Patent Application Ser. No. 63/513,058, filed Jul. 11, 2023, the disclosure of which is hereby incorporated, by reference, in its entirety.

### BACKGROUND OF THE INVENTION

### 1. Field of the Invention

Embodiments relate to systems and methods for generating semi-structured term sheets using neural information retrieval.

### 2. Description of the Related Art

Creating term sheets is a long process with a very high volume. Current automatic approaches are rule-based and lack the flexibility needed to provide reliable results. Hence, it creates a high cost of manual review and potentially legal services to review the generated term sheets. Manual review also can introduce new bugs and mistakes. Maintenance to update the rules is similarly taxing. Further, in existing term sheets, using rule-based techniques can result in a minor change, such as formatting or a style of term, can result in breaking the process of term sheet creation.

### SUMMARY

Embodiments relate to systems and methods for generating semi-structured term sheets using neural information retrieval.

Systems and methods are disclosed for generating a semi-structured term sheet. According to some embodiments, the systems and methods include receiving a brief description of a term sheet in a natural language format from a user interface connected to the electronic device; tokenizing the brief description to create a plurality of numerical values for a content of the brief description; using a large language model to retrieve information relevant to the brief description based on the tokenization; selecting a dynamic template database to the information retrieved by the large language model based on the retrieved information; querying the dynamic template database using the retrieved information to extract a term; and outputting the terms in a determined format based on the dynamic template database.

In some embodiments, the systems and methods can include using a term sheet sample to infer a dynamic template and select the dynamic template from the dynamic template database. In some embodiments, the systems and methods can include extracting a rule for generating a new term from the extracted term. In some embodiments, the systems and methods can include where the querying step occurs more than once, collating the output for each query.

### BRIEF DESCRIPTION OF THE DRAWINGS

FIG. 1 is a block diagram of a system for providing a semi-structured term sheet, in accordance with aspects.

FIG. 2 is a sequence diagram for generating a table for a semi-structured term sheet, in accordance with aspects.

FIG. 3 is a sequence diagram for generating a dynamic template, in accordance with aspects.

FIG. 4 is a logical flow for generating a semi-structured term sheet, in accordance with aspects.

FIG. 5 is a system for generating semi-structured term sheets using neural information retrieval, in accordance with aspects.

FIG. 6 is a block diagram of a computing device, in accordance with aspects.

### DETAILED DESCRIPTION OF PREFERRED EMBODIMENTS

Embodiments relate to systems and methods for generating semi-structured term sheets using neural information retrieval.

In one embodiment, a neural information retrieval framework may use machine learning techniques to generate semi-structured term sheets based on brief descriptions that may be written in natural language. Embodiments may enable users to quickly and easily create complex term sheets that are more accurate and less error-prone than existing rule-based techniques. Embodiments may be robust to perturbations or noisy inputs in the input data. Embodiments can reduce or eliminate manual review.

Embodiments may be robust to perturbations in the input data (i.e., a brief description of the term sheet), such as a different formatting, different number of inputs, the use of synonyms, acronyms, and abbreviations.

Embodiments may provide customizability through the use of dynamic templates (e.g., questions) to retrieve the information in the brief description. These dynamic templates may use natural language, which makes them easier to create and modify than rules in code.

Embodiments may be generalized to non-predefined types of term sheets (e.g., those with no tailored templates) due to their understanding of natural language.

Because embodiments may use natural language, the brief descriptions may be written in a user-friendly and readable manner. It may also take less time to write the brief descriptions in natural language.

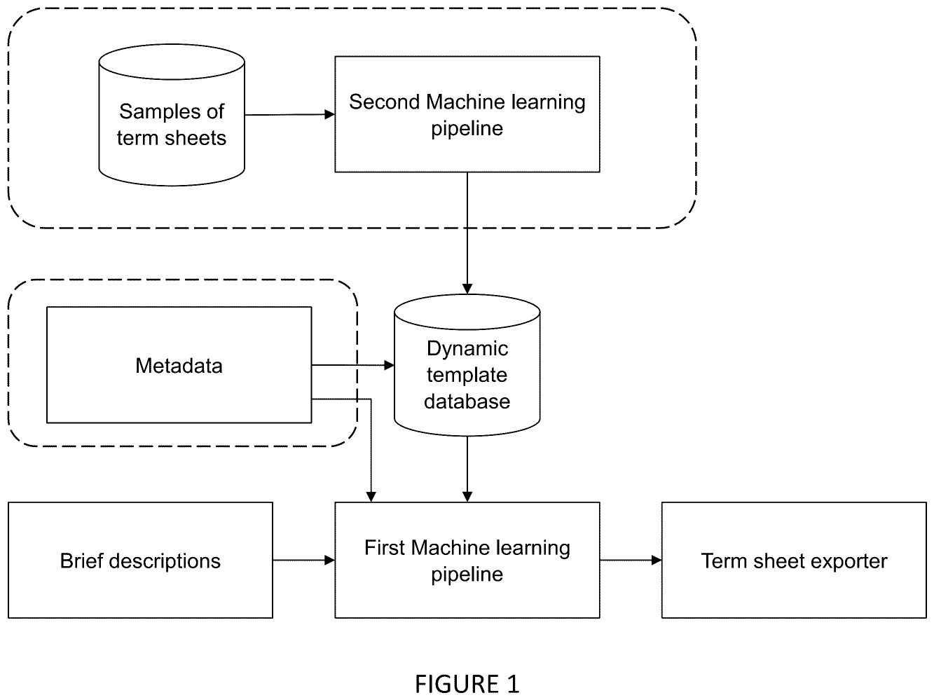

Referring to FIG. 1, a system for generating semi-structured term sheets using neural information retrieval is disclosed according to an embodiment. The system may include brief descriptions, which may be one or more (batch mode) brief descriptions in natural language about the term sheet(s) the user wants to generate; a dynamic template database, which may be a database (e.g., MySQL, list) of dynamic templates; a first machine learning pipeline, which may be a pipeline built around a machine learning model that uses the brief description and the dynamic templates to generate a term sheet using natural language processing techniques; a term sheet exporter, which may transform the output of the machine learning model into the correct format(s) (e.g., pptx, docx, etc.), metadata, which may include, for example, a desired output format and a manual dynamic template the user wants to use; samples of term sheets, which may include a dataset of term sheet samples that can be used to infer dynamic templates; and a second machine learning pipeline, which may be a pipeline built around a machine learning model that uses the term sheet samples to infer dynamic templates that are processed and stored in the dynamic template database.

The dynamic template database may include queries (e.g., questions) to retrieve the right information from brief description, as schemas (e.g., Kor library) with optional examples, as a prompting language (e.g., guidance from Microsoft), etc. An agent may automatically match the input brief description with the best dynamic template based on rules or machine learning, such as the zero-shot-react-description from Langchain.

Otherwise, the dynamic template to use can be provided by the user in the metadata. Metadata can include information like the desired output format and/or the manual dynamic template the user wants to select.

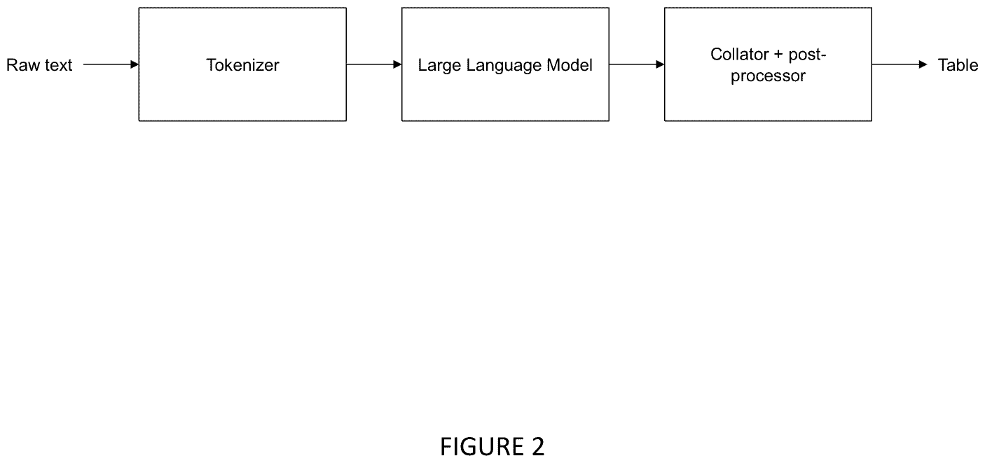

FIG. 2 is a sequence diagram for generating a table for a semi-structured term sheet, in accordance with aspects.

The first machine learning pipeline may include at least one machine learning model. The first machine learning pipeline may include components that help the machine learning model to process the information and make intelligent decisions. For example, with Large Language Models (LLMs), a pre-processing step may be used to tokenize the inputs so the model receives numerical values instead of text. These tokens may be processed by the LLM to retrieve the information from the brief description. In other words, textual terms are mapped to numerical values (e.g., integers) using byte-mapping. The numerical values can then index into a real-valued vector embedding table. The table can be a deep representation of the corresponding term. The vectors can be fed into the LLM as an input.

Finally, in the case of a query-based dynamic template database, embodiments may collate the output received for each question, and post-process the result to obtain a table. Each template extracts a specific item from the brief description (e.g., issuer, commission). Each of the extracted items is used to populate the relevant field in the generated term sheet (e.g., in a table).

In one embodiment, the large language model may be trained on information from a database of term sheets. The information can be financial information. The information can be an issuer, a commission, and/or an offering size. The database may be specific to an organization, to a portion of an organization (e.g., a line of business, a department, a group, etc.), to a specific product, may be provided by a third party (e.g., a third party collection of term sheets), etc.

Further post-processing may be needed to export the term sheet in the desired format (e.g., pptx, docx).

An example of a first machine learning pipeline is provided in FIG. 2.

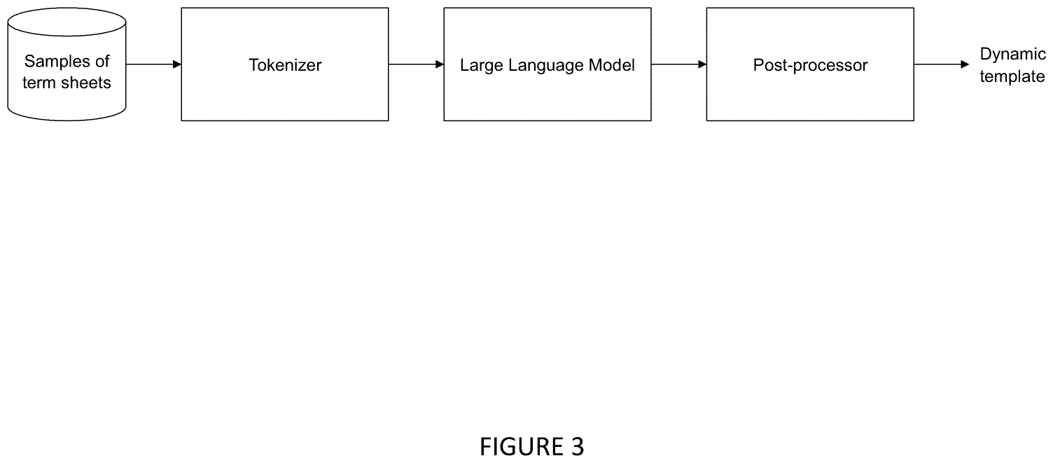

FIG. 3 is a sequence diagram for generating a dynamic template, in accordance with aspects.

The second machine learning pipeline, which is optional, may generate dynamic templates based on term sheet samples. For example, embodiments may use a generative LLM with a tokenizer that analyzes existing term sheets to infer rules. These rules may be inferred by prompting the LLM with instructions, such as “create an accurate instruction to prompt a large language model to generate the following paragraph”. These prompts may be specific and may include examples of paragraphs and corresponding prompting language. An LLM may also be fine-tuned to replicate this behavior. For instance, the LLM may be prompted with raw text and the corresponding meta language. Meta language can be an overarching instruction to perform a task. Meta language can be an instruction or language about the language of the prompt.

An example of a second machine learning pipeline is provided in FIG. 3.

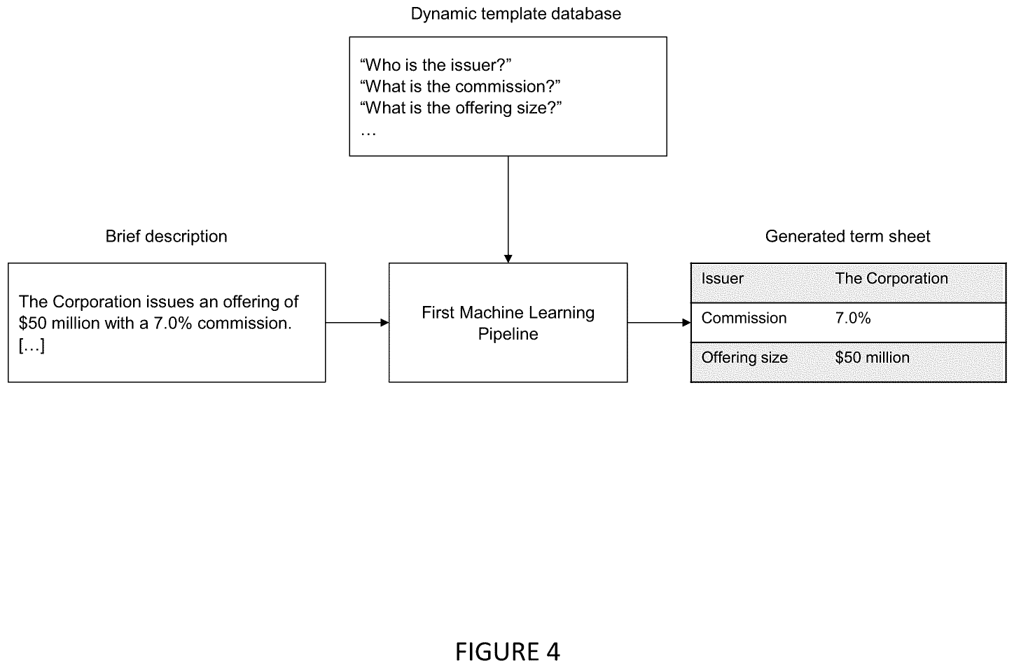

FIG. 4 is a logical flow for generating a semi-structured term sheet, in accordance with aspects.

An illustrative example of a dynamic template database, a brief description, a first machine learning pipeline, and a generated term sheet are provided in FIG. 4. As illustrated, a user may enter a brief description, such as “The Corporation issues an offering of $50 million with a 7.0% commission.” The dynamic template database may include questions, such as “who is the issuer?” “What is the commission?” “What is the offering size?” The first machine pipeline may apply the dynamic template database to the brief description to generate a term sheet. The LLM can use the brief description to find a subset of dynamic templates to apply.

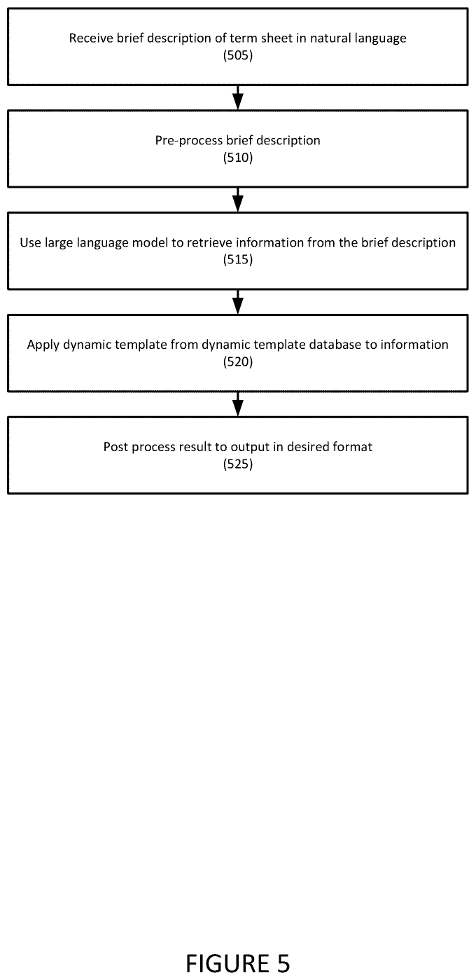

Referring to FIG. 5, a system for generating semi-structured term sheets using neural information retrieval is disclosed according to an embodiment.

In step 505, a computer program may receive brief description of a term sheet in natural language format from a user interface.

In step 510, a first machine learning pipeline may pre-process the brief description. For example, the first machine learning pipeline may tokenize the brief description to create numerical values for the content.

In step 515, the first machine learning pipeline may use a large language model that uses a dynamic template of a dynamic template database to extract information from the brief description to generate a term sheet, consistent with disclosed embodiments. Any suitable large language model may be used as is necessary and/or desired.

In step 520, the first machine learning pipeline may select and apply a dynamic template from a dynamic template database to the information retrieved by the large language model. The dynamic template may include queries that may be used to extract terms for the terms sheet from the information.

In step 525, the computer program may post-process the results to output the terms in a desired format, such as a chart. The computer program may transform the output of the machine learning model into a desired format, such as one selected from the metadata. In some embodiments, a deterministic program can generate an output format.

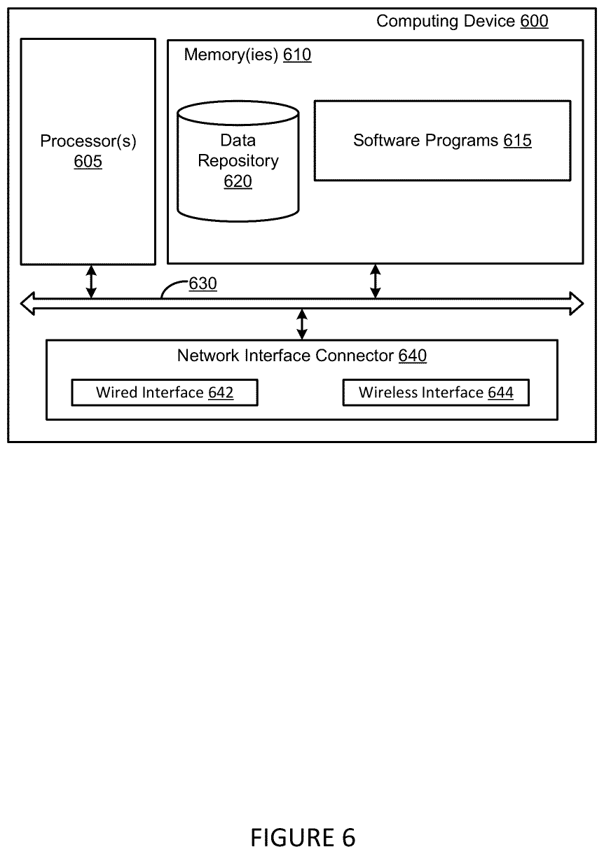

FIG. 6 is a block diagram of a computing device, in accordance with aspects.

FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed on an electronic device, a brief description of a term sheet in a natural language format from a user interface connected to the electronic device;
tokenizing, by the computer program, the brief description to create a plurality of numerical values for a content of the brief description;
using, by the computer program, a large language model to retrieve information relevant to the brief description based on the tokenization;
selecting, by the computer program, a dynamic template database to the information retrieved by the large language model based on the retrieved information;
querying, by the computer program using the large language model, the dynamic template database using the retrieved information to extract a term; and
outputting, by the computer program, the terms in a determined format based on the dynamic template database, the format being determined based on the extracted term.

2. The method of claim 1, further comprising using a term sheet sample to infer a dynamic template and select the dynamic template from the dynamic template database.

3. The method of claim 1, further comprising extracting a rule for generating a new term from the extracted term.

4. The method of claim 1, further comprising, wherein the querying step occurs more than once, collating the output for each query.

5. The method of claim 1, further comprising selecting the dynamic template based a zero-shot-react-description.

6. The method of claim 1, further comprising generating a new dynamic template based on the terms and a meta instruction.

7. The method of claim 1, further comprising post-processing the terms into a chart.

8. A non-transitory computer readable storage medium, including instructions stored thereon, which when read and executed by one or more computers cause the one or more computers to perform steps comprising:
receiving, by a computer program executed on an electronic device, a brief description of a term sheet in a natural language format from a user interface connected to the electronic device;
tokenizing, by the computer program, the brief description to create a plurality of numerical values for a content of the brief description;
using, by the computer program, a large language model to retrieve information relevant to the brief description based on the tokenization;
selecting, by the computer program, a dynamic template database to the information retrieved by the large language model based on the retrieved information;
querying, by the computer program using the large language model, the dynamic template database using the retrieved information to extract a term; and
outputting, by the computer program, the terms in a determined format based on the dynamic template database, the format being determined based on the extracted term.

9. The instructions of claim 8, further comprising using a term sheet sample to infer a dynamic template and select the dynamic template from the dynamic template database.

10. The instructions of claim 8, further comprising extracting a rule for generating a new term from the extracted term.

11. The instructions of claim 8, further comprising, wherein the querying step occurs more than once, collating the output for each query.

12. The instructions of claim 8, further comprising selecting the dynamic template based a zero-shot-react-description.

13. The instructions of claim 8, further comprising generating a new dynamic template based on the terms and a meta instruction.

14. The instructions of claim 8, further comprising post-processing the terms into a chart.

15. A computer processing system comprising:
a memory configured to store instructions; and
a hardware processor operatively coupled to the memory for executing the instructions to:
receive a brief description of a term sheet in a natural language format from a user interface connected to the electronic device;
tokenize the brief description to create a plurality of numerical values for a content of the brief description;
use a large language model to retrieve information relevant to the brief description based on the tokenization;
select a dynamic template database to the information retrieved by the large language model based on the retrieved information;
query the dynamic template database using the retrieved information to extract a term; and
output the terms in a determined format based on the dynamic template database, the format being determined based on the extracted term.

16. The system of claim 15, further comprising using a term sheet sample to infer a dynamic template and select the dynamic template from the dynamic template database.

17. The system of claim 15, further comprising extracting a rule for generating a new term from the extracted term.

18. The system of claim 15, further comprising, wherein the querying step occurs more than once, collating the output for each query.

19. The instructions of claim 15, further comprising selecting the dynamic template based a zero-shot-react-description.

20. The instructions of claim 15, further comprising generating a new dynamic template based on the terms and a meta instruction.
